(19) United States
(12) Patent Application Publication
(10) Pub. No.: US 2022/0148077 A1
(43) Pub. Date: May 12, 2022

(54) Method And System For An Electronic Auction And Sweepstakes

(71) Applicant: Epic Tech, LLC, Suwanee, GA (US)

(72) Inventors: Bobby Mosley, Piedmont, SC (US); Brian Bonnette, Anderson, SC (US); Troy Jungmann, Austin, TX (US)

(73) Assignee: Epic Tech, LLC, Suwanee, GA (US)

(21) Appl. No.: 17/584,016

(22) Filed: Jan. 25, 2022

Related U.S. Application Data
(63) Continuation of application No. 16/294,892, filed on Mar. 6, 2019, now abandoned.
Application No. 16/294,892 is a continuation of application No. 15/168,721, filed on May 31, 2016, now abandoned.
Application No. 15/168,721 is a continuation of application No. 13/745,273, filed on Jan. 18, 2013, now abandoned.
(60) Provisional application No. 61/708,690, filed on Oct. 2, 2012.
(60) Provisional application No. 61/622,786, filed on Apr. 11, 2012.

(51) Int. Cl. G06Q 30/08; G06Q 30/02

(52) U.S. Cl. CPC G06Q 30/08; G06Q 30/0209; G06Q 30/0212

(57) ABSTRACT

A system for allowing a user to participate in an electronic auction and an electronic sweepstakes game includes a processor configured to (1) receive a request to purchase a first quantity of bids, (2) enable purchase the first quantity of bids, (3) allocate the first quantity of purchased bids and a first quantity of electronic sweepstakes entries to an account of the purchase, (4) enable the purchaser to use one of the first quantity of bids to bid on a first item, (5) receive a request to reveal one of the first quantity of sweepstakes entries, (6) enable the user to reveal the one sweepstakes entry, and (7) enable the display of a result selected from a group consisting of the auction of the item and the reveal of the at least one sweepstakes entry.

### CROSS REFERENCE TO RELATED APPLICATIONS

This application is a continuation of U.S. patent application Ser. No. 13/745,273 filed Jan. 18, 2013, which claims the benefit of and incorporates by reference, in its entirety, U.S. Provisional Patent Application No. 61/622,786, filed Apr. 11, 2012 and U.S. Provisional Patent Application No. 61/708,690, filed Oct. 2, 2012.

### BACKGROUND

Online auctions are a new method of selling products to consumers. A consumer can typically purchase an item for a discount from retail by participating and winning the online electronic auction. However, online auctions may not hold a buyer's attention for a long period of time. The present system and methods recognize and address the forgoing considerations, and others, of prior art system and methods.

### SUMMARY OF THE INVENTION

In an embodiment, the invention is directed to a computer-implemented method of providing an electronic auction and an electronic sweepstakes system that receives a request to purchase a first quantity of electronic bids for use in at least one electronic auction. The bids may be purchased in any quantity and some embodiments the bids may be purchased in packages. In various embodiments, the system allocates the first quantity of electronic bids to an account associated with the purchaser. The account may be a preexisting account or a newly created account on the system. In various embodiments, the system also allocates a first quantity of electronic sweepstakes entries to the purchaser's account.

The bids may be allocated to the purchaser's account once the purchaser submits payment for the bids, at which time the purchased bids are transferred to the account. The number of allocated sweepstakes entries may vary depending on the number of bids purchased, the value of the bids purchased, the length of time the purchaser has had an account on the system, or any other variables that the system may use in determining the number of sweepstakes entries to allocate to the purchaser's account. For example, in some embodiments, the purchaser may receive two sweepstakes entries for each bid purchased, and in other embodiments, the purchaser may receive one sweepstakes entry for every two bids purchased.

The system may also be configured to receive a request from the purchaser to place a bid on a first item available in the at least one electronic auction. At least partially in response to receiving the request to place a bid, the system enables the purchaser to place the bid on the first item. The system may also require the user to reveal a sweepstakes entry before enabling the purchaser to place the first bid. In other embodiments, the system may be configured to receive a request from the purchaser to reveal a result of at least one of the first quantity of electronic sweepstakes entries that were allocated to the purchaser when the bids were purchased. In various embodiments, the system may enable the purchaser to reveal the result of the at least one electronic sweepstakes entry. In various embodiments, the system may be configured to facilitate a display of the auction results and/or the results of the sweepstakes reveal.

In various embodiments, the system may be configured to reveal a sweepstakes entry each time the purchaser bids on an item. In other embodiments, the purchaser cannot reveal the result of a sweepstakes entry until at least one bid is used. In still other embodiments, the purchaser cannot reveal the results of a sweepstakes entry until all purchased bids associated with the allocated sweepstakes entries are used.

A system for allowing at least one user to participate in an electronic auction and an electronic sweepstakes game, in accordance with various embodiments, comprises at least one processor and memory operatively coupled to the at least one processor. The processor is configured to (1) receive a request from a first user to purchase a first quantity of bids, (2) enable the first user to purchase the first quantity of bids, (3) allocate the first quantity of purchased bids and a first quantity of electronic sweepstakes entries to an account of the first user, (4) enable the first user to use at least one of the first quantity of bids to bid on a first item available in the electronic auction, (5) receive a request to reveal at least one of the first quantity of sweepstakes entries, (6) at least partially in response to receiving the request to reveal the at least one of the first quantity of sweepstakes entries, enable the user to reveal the at least one sweepstakes entry, and (7) enable the display of a result selected from a group consisting of the auction of the item; and the reveal of the at least one sweepstakes entry.

In various embodiments, the reveal of at least one sweepstakes entry may also be based on whether the user has placed a bid on an item. In still other embodiments, the reveal may also be based on whether the user has selected a display style (e.g., the type of game used to display the results) for displaying the results. In still other embodiments, the user may reveal one sweepstakes entry for each bid submitted.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 shows a block diagram of an exemplary electronic auction and sweepstakes system in accordance with an embodiment of the present system;

FIG. 2 shows a block diagram of a computer that may be used, for example, as a end user terminal or server computer within the context of system of FIG. 1;

FIG. 3 shows exemplary method steps carried out in accordance with an auction and sweepstakes module for use in the system of FIG. 1; and

FIG. 4 shows exemplary method steps carried out in accordance with an auction and sweepstakes module for use in the system of FIG. 1.

### DESCRIPTION OF SOME EMBODIMENTS

Reference will now be made in detail to embodiments of the present systems and methods, one or more examples of which are illustrated in the accompanying drawings. Each example is provided by way of explanation, not limitation of the present system. In fact, it will be apparent to those skilled in the art that modifications and variations can be made to the present system and methods without departing from the scope or spirit thereof. For instance, features illustrated or described as part of one embodiment may be used in another embodiment to yield a still further embodiment. Thus, the present system and methods cover such modifications and variations as come within the scope of the appended claims and their equivalents.

### Overview

The present systems and methods are directed generally to an electronic auction and sweepstakes game. Generally speaking, the software system provides a server-based and/or Internet-based auction, which may also utilize a server-based and/or Internet-based promotional sweepstakes game. One such sweepstakes game, which is hereby incorporated in its entirety, is disclosed in U.S. patent application Ser. No. 13/617,105, filed Sep. 14, 2012, entitled Gaming System and Method.

In various embodiments, the system may be server-based and may be utilized in a brick and mortar location. In these embodiment, the brick and mortar business sells “bids” that may be used for bidding on items for sale in the electronic auctions. The bids may be sold in groups or packs. For example, bids may be sold in a pack of 100 bids. In various embodiments, bids purchased from the brick and mortar business, rather than from an Internet-based home computer, may be less expensive. For example, a bid pack purchased from the brick and mortar store may be $0.45 rather than $0.60 per bid. Note that throughout this application, the electronic product used to participate in an auction is referred to as a “bid,” but this product may be any electronic product known in the art to be useful to designate participation in an electronic auction.

In various embodiments, the initial purchase of bids is through a human cashier. In such embodiments, the inventive software system is operated on a cashier kiosk, computer, or other terminal which allows such a customer to make such a purchase. The software allows the input of number of bids desired to be purchased, calculates the price of such bids, confirms the purchase of such bids, and transfers the bids to an electronic account that is personal to the customer. The customer may then use a computer located at the brick and mortar location to access the auction and sweepstakes software or may exit the brick and mortar location and access the auction and sweepstakes from any computer connected to the Internet.

In other embodiments, the system comprises a purchase of bids by a customer directly through a kiosk, computer, or other terminal (no human cashier necessary) located in a brick and mortar location. In these embodiments, a customer may approach the kiosk, computer, or terminal (hereinafter the “terminal”), input a method of payment, and purchase the desired number of bids. In various embodiments, the customer may then use the same terminal, a separate computer or an end user terminal located in a brick and mortar location to access the electronic auction and sweepstakes. Alternatively, the customer may exit the brick and mortar location and access the electronic auction and sweepstakes from any computer connected to the Internet.

In alternate embodiments, access to the system, including purchase of bids, use of the electronic auction, and use of the electronic sweepstakes, can be implemented from any computer connected to the Internet and not related to a brick and mortar store. The system may be available over the Internet and all data may be stored on one or more physical servers and/or on a cloud server. The purchase of bids may be accomplished via credit card, debit card, PayPal® account, or similar service.

Once the customer purchases the bids, the system may be configured to allocate a predetermined number of sweepstakes entries to the user's account. The number of sweepstakes entries may be fixed, may be proportional to the number of purchased bids, or may be based on any other relevant factors. In various embodiments, the customer may request that one or more sweepstakes entries be revealed before, during, or after participating in an electronic auction. The customer may request a reveal of at least one entry by selecting a button or link on a computer terminal that is being used to access the electronic auction. In various embodiments, the user may need to log in to a separate system to reveal the results of the electronic sweepstakes entries.

In various embodiments, the electronic auction may be configured to receive bids from one or more users. In some embodiments, the winner of the auction may win the item being auctioned if their bid is the highest bid, without further payment. In other embodiments, the winning bidder may be required to pay the highest bid that was required to win the electronic auction. In still other embodiments, all losing bidders may be able to purchase the auctioned item for a predetermined price. In some of these embodiments, the amount of bids expended during the auction may be used to offset the final price that must be paid by the losing bidders.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System

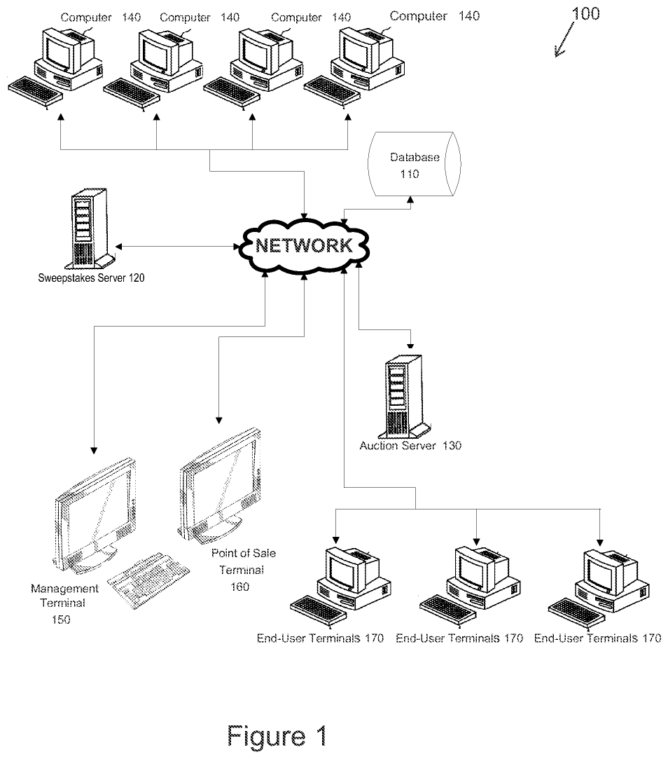

FIG. 1 illustrates a system 100 for providing an online auction and electronic sweepstakes game in accordance with an embodiment of the present invention. The system 100 comprises a database 110, at least one sweepstakes server 120, at least one auction server 130, one or more computers 140, a management terminal 150, a point-of-sale (“POS”) device 160, and one or more standalone sweepstakes end user terminals 170, or any combination thereof. Those skilled in the art with reference to this disclosure should appreciate that other configurations may be used to accomplish the methods described herein without departing from the scope of the present invention. For example, in various embodiments, sweepstakes server 120 may be configured to also provide the functionality provided by auction server 130.

It should be understood that each of the computing devices, including the sweepstakes server 120, the auction server 130, computers 140, the management terminal 150, the POS device 160, and the one or more end user terminals 170, may each have a computer hardware processor, input and output devices (for example, a computer monitor, a keyboard, selection buttons, and/or mouse) and at least one storage device (for example, memory, hard drives, etc.). These devices may also have network connection cards to connect to the network. At least some of these devices may also include a computer readable medium, which is further described herein.

Sweepstakes server 120 and auction server 130 are configured to communicate data from various devices in the system and to perform one or more method steps, as detailed below. Database 110 may contain various types of data and computer instructions for performing at least some of the steps presented herein. Although a single server is indicated for sweepstakes server 120, auction server 130, and a single database for database 110, it should be understood that the network may be comprised of multiple servers and databases, whether located locally and networked through a LAN or remotely through a WAN or an Intranet connection. Thus, the single representations at 120, 130, and 110 are provided for purposes of illustration and clarity only and should be understood to represent such other configurations.

Computers 140 and end user terminals 170 are illustrated as linked together via a network (which may be via the network shown in FIG. 1 or any additional network). Each end user terminal may be a standard standalone end user terminal 170, a personal computer (PC) 140 or other computing device (not shown). Computers 140 and end user terminals 170 are illustrated in FIG. 1 as separate groups (even though they function similarly and perform the same method steps). Computers 140 may be located local to the end user terminals 170 or they may be computers owned by users and located remotely from the servers and other end user terminals. Moreover, computers 140 and end user terminals 170 may each be configured to access online auctions in addition to allowing the customer to play their sweepstakes entries. Thus, for purposes of this disclosure, computers 140 and end user terminals 170 are interchangeable and may be configured to function in the same manner.

POS device 160 allows a user to buy bids or another product or service and receive the bids and associated sweepstakes entries that are allocated to the user's account. Play of the end user terminals could be free with such purchases. In various embodiments, the user may use the POS device 160 to directly load an account card with bids to use in an online auction to play sweepstakes games on the end user terminals. This account card is associated with the account that the user may use to play the sweepstakes game on a computer 140 or end user terminal 170. The account card may also be used to participate in electronic auctions and to place bids on items that the customer wishes to purchase.

If a user enters a brick and mortar location, POS device 160 may provide the user with a receipt containing a code, such as a 16-digit hexadecimal code, that the user may then use to access his/her account on a kiosk, computer 140, end user terminal 170, or other terminal. In an online embodiment, the user may access software through a browser interface that may display a similar code to the user. This code may provide access to the auction software/website and/or specifically to the customer's account on the software/website. In various embodiments, the user may be required to input certain biographical information, such as name, cellular phone number, username, password, date of birth, and/or email address when making a bid purchase using any of the methods described herein. Such information may be stored in database 110.

In various embodiments, the system allows a user to deposit currency into an electronic wallet and then purchase bids on an as-needed basis. In yet other embodiments, the system allows a customer to purchase electronic currency and later use that electronic currency to purchase bids. In still other embodiments, a bid is purchased and used at the same time (i.e. bids are not purchased in advance and then used later, instead both purchase and use of a bid occur simultaneously).

Management terminal 150 may be a device that is operatively connected with sweepstakes server 120 or auction server 130 to initiate, enable, disable, or change a sweepstakes or the online auction of an item. Other managerial or supervisory operations may also be performed using management terminal 160.

Auction server 130 controls one or more operations of the online auction of items, such as displaying the item being auctioned, running the online auction by receiving bids, tracking bids, monitoring the start and end of an auction, tracking the winner of the auction, and/or any other operations as discussed herein. In some embodiments, auction server 130 is part of the sweepstakes server 120 such that server 120 performs all or part of the operations of auction server 130.

One or more of the devices illustrated in FIG. 1 may be connected to a network as previously mentioned. In one embodiment, all devices in FIG. 1 are connected to the network and communicate with each other over the network. It should be noted that the network in FIG. 1 need not be a single network (such as only the internet) and may be multiple networks (whether connected to each other or not). In another embodiment, the network may be a LAN and a WAN (e.g., the Internet) such that one or more devices (for example, sweepstakes server 120, auction server 130, management terminal 150 and database 110) are connected together via the LAN, and the LAN is connected to the WAN which in turn is connected to other devices (for example, computers 140 and end user terminals 170). The terms “linked together” or “connected together” refers to devices having a common network connection via a network (either directly on a network or indirectly through multiple networks), such as one or more devices on the same LAN, WAN or some network combination thereof.

It should be understood that FIG. 1 is an exemplary embodiment of the present system and various other configurations are within the scope of the present system. For example, each computer terminal 140 may be located in a user's home, management terminal 150, point of sale terminal 160 and end user terminals 170 may all be located in a brick and mortar business location and sweepstakes server 120 and auction terminal 130 may be located in still another location, where all of these system components are operatively coupled by a network such as the Internet. Additionally, it should be understood that additional devices may be included in the system shown in FIG. 1, or in other embodiments, certain devices may perform the operation of other devices shown in the figure.

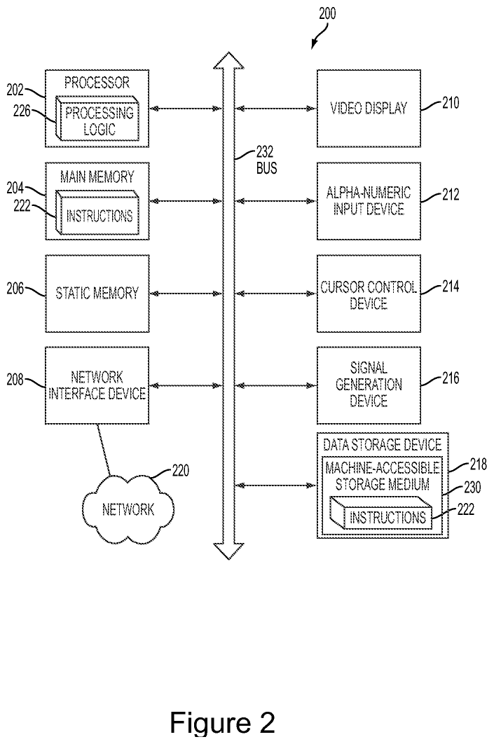

FIG. 2 illustrates a diagrammatic representation of a computer architecture 200 that can be used within the system 100 of FIG. 1, for example, as computer 140 or end user terminals 170, or as a server computer (e.g., sweepstakes server 120 or auction server 130). For purposes of this disclosure, reference to a server or processor, shall be interpreted to include: a single server, a single processor; multiple servers; multiple processors; or any combination of servers and processors.

In particular embodiments, the computer implemented by architecture 200 may be connected (e.g., networked) to other computers by a LAN, an intranet, an extranet, and/or the Internet. The computer may operate in the capacity of a server or a client computer in a client-server network environment, or as a peer computer in a peer-to-peer (or distributed) network environment. The computer may be a (PC 140, a tablet PC, a handheld device, a set-top box (STB), a Personal Digital Assistant (PDA), a web appliance, a server 120, 130, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

The exemplary computer architecture 200 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

Processor 202 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), a network processor, or the like. Processor 202 may be configured to execute processing logic 226 for performing various operations and steps discussed herein.

Computer architecture 200 may further include a network interface device 208. Computer architecture 200 also may include a video display 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

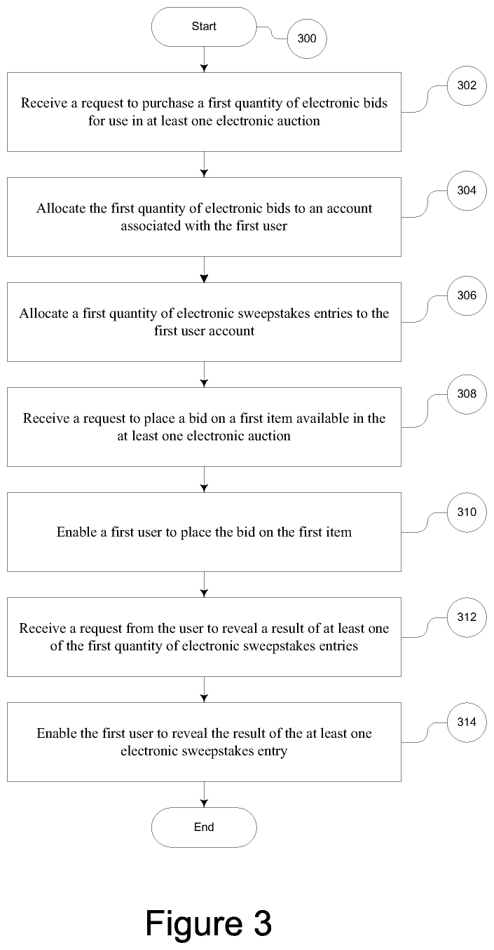

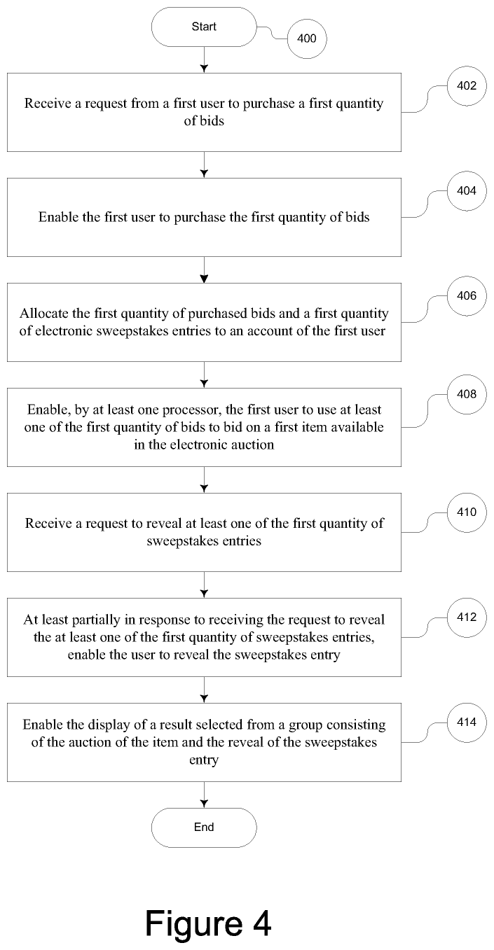

Data storage device 218 may include a machine accessible storage medium 230 (also known as a non-transitory computer-accessible storage medium, a non-transitory computer-readable storage medium, or a non-transitory computer-readable medium) on which is stored one or more sets of instructions embodying any one or more of the methodologies or functions described herein (e.g., an online auction module and sweepstakes module, which carry out the steps disclosed in FIGS. 3 and 4). The online auction and sweepstakes modules may also reside, completely or at least partially, within main memory 204 and/or within processing device 202 during execution thereof by computer 200. Main memory 204 and processing device 202 also constitute computer-accessible storage media. Instructions 222 may further be transmitted or received over a network 220 via network interface device 208.

While machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media.

### Auction Module

The auction module that resides on auction server 130 may provide various auction functionalities as discussed herein. In various embodiments, the user may access the online auction site through computer 140 or end user terminal 170. In accessing the online auction site, the user may be presented with a welcome screen and asked to enter a code, username and password, or other identifying data. Once entered and confirmed, the system may permit the user to view his auction account. The user's auction account may contain information about the user, including, but not limited to, various biographical data, payment data, and number of bids available for use. The system may display an option for the user to continue to view auctions in progress. If the user elects to continue to view the auctions in progress, the user may view the products that are currently being auctioned and/or available for outright purchase at their retail price. There may be one product available for auction or there may be many products available for auction. The products may be various consumer goods, such as cameras, phones, laptops, sports equipment, etc. In various embodiments, the products may be sporting event tickets, vacation packages, gift cards, bid packs, or any other product that may be sold through an online auction. Each auction may include photographs, product descriptions, product images, or any other relevant information that may be displayed to the user to identify the product being auctioned.

In various embodiments, the system presents the user with an option to bid on one or more of the products and the user must then choose which products to bid on. In some embodiments, the user must manually bid upon each product that has been selected. In other embodiments, the system provides an automatic feature that, if selected, automatically bids for the user if another bidder outbids the user on the product. In some embodiments, the system may provide the option for manual bidding or automated bidding when the user views an auctioned product. In some of these embodiments, the automated bidding function operates such that once a user is the high bidder on the first product that they have selected, the system moves to the second item and bids, and once the user is the high bidder on the second product, the inventive system moves to the third item, and so on. In another embodiment, the automated bidding system operates such that any time someone outbids a user (no matter how many products have been selected for auction), it attempts to bid again so that the user is again the high bidder of all selected auctions as quickly as possible. In a particular embodiment, the system allows the user to designate a priority of the products he wants to bid on so that the automated bidding system bids on those products first.

The manual or automated bidding options may apply to all products selected or may be individually selected for each product. That is, a user could use the automated bidding function on a high priority product and manually bid on a lower priority product, if desired. In various embodiments, the user may simultaneously bid on more than one product. The automated auction function may end when the auction ends or when the user has depleted his bids. In some embodiments, the auction may allow the user to redeem (e.g., use) one bid for each opportunity to win/purchase the item being auctioned. Thus, if a user has a 100-bid pack, the user may have 100 opportunities to win/purchase the item. In other embodiments, higher value products (e.g., a car) may require more than one bid per opportunity to win/purchase the item. In an embodiment, the software provides the user with a list or selection of products and identifies the minimum number of bids required to participate in the auction.

In yet other embodiments, bids for higher value products cost more than bids for lower value products. For example, the software may provide levels of products, wherein the first product level offers products that have a retail value of $100 or less; the second product level offers products that have a retail value between $101 and $1000; and the third product level offers products that have a retail value above $1000. In such case, the bids for the third product level may cost more than the bids for the first product level. Alternatively, more than one bid for each bidding round may be required to participate in the auction on the third product level. For example, in level one auction, each bid requires the user to redeem one bid, in a level two auction each bid requires the user to redeem three bids, and in a level three auction each bid requires the user to redeem ten bids.

In another embodiment, the various product levels may correspond with customer status. For example, a customer that is a frequent bidder may be given a priority status and have access to products on a different value level. That is, for priority bidders, level one auction may include products that have a retail value of $500 or less, a level two auction may include products that have a retail value between $501 and $5,000, and a level three auction may include products that have a value of $5,001 and up.

With regard to the user interface, the system may provide a designated area in the user interface that displays the real-time status of various auctions selected by the user. The auctions status may also be delayed and not necessarily shown in real-time depending on the embodiment of the system. In various embodiments, the display may include a “hot button,” which is a designated link that allows the user to immediately bid on a product for an ongoing auction. In this way, the user does not need to navigate through layers of screens to get to an auction that requires the user's immediate attention.

In various embodiments, the auction may be local and server-based. The products being bid upon may be accessed only by users in the particular brick and mortar location where the relevant auction server is located or, in another embodiment, in a particular city, county, or state where the relevant auction server is located. In another embodiment, however, the same auctions may be accessed by any customer across various states or nationwide. In this embodiment, the inventive software and data may be housed in a centralized server and/or cloud server.

Regarding the format of the auction itself, the bidding may be conducted in any manner. In one embodiment of the auction, when there are 15 seconds left in the auction, every time a bid is made, the timer will reset, allowing another bidder to place a bid. The last person to bid wins the item at the expiration of the fifteen seconds on the timer after the last bid.

In some embodiments, the auction may be an English auction or standard auction, wherein bidders bid for a period of time until bidding significantly slows or ceases. Multiple items could be bid upon if desired.

In another embodiment, the bidding may be conducted via a reserve price auction or a minimum bid auction. In this type of auction, a reserve price may be posted or may be hidden to bidders. In some embodiments, there may be no reserve price, but a specified minimum bid. In this embodiment, all bids above the minimum bid may be allowed. In another embodiment, the reserve price may be posted, but there may not be a minimum bid. In this embodiment, all bids are allowed, but only bids above the reserve price can win. In another embodiment, there may be a posted reserve price and a specified minimum bid. In this embodiment, all bids above the minimum are allowed, but only bids above the reserve can win. In yet another embodiment, the reserve price may be secret or hidden, and there may be no minimum bid. In this embodiment, all bids are allowed, but only bids above the reserve price can win. Lastly, the auction may have a secret or hidden reserve price and the minimum bid may be specified. In this embodiment, all bids above the minimum are allowed, but only bids above the reserve can win.

In yet another embodiment, the auction may be a proxy price auction, wherein a robot or auto bidding script automatically bids for a user, up to the maximum bid they are willing to spend. In this embodiment, if another bidder's bid is higher than the user's maximum, the system notifies the user to request a new desired maximum bid, if any.

In still another embodiment, the bidding may be executed through a sealed bid auction or “yankee auction.” In this type of auction, all users submit closed/sealed bids and when a time period ends, the bids are unsealed and the highest bidder wins.

In yet another embodiment, the bidding may be through a Dutch auction or “reverse auction.” In this embodiment, the auction price starts at a high price. At specified time intervals, the auction price drops by a fixed amount. The first bidder to bid wins.

In other embodiments, the auction may be a Japanese auction or “poker auction.” In this embodiment, users sign up to participate in the auction. Once the auction begins, no new users may join the auction. Once the bid increases, everyone must bid or drop from the auction within a specified period of time. The last bidder to remain in the auction wins.

In another embodiment, the auction may be a Chinese auction or “raffle auction.” In this embodiment, bidders commit to a certain number of bids at the outset. Each bid is assigned a number. The winning bidder is randomly selected from the total number of entries.

In various embodiments, the auction may be another form of Chinese auction also referred to as a “dirty Santa auction.” In this embodiment, the users must elect to participate in the auction from the outset. A number of designated buttons or boxes may be displayed on the screen. A first user selects a button or box. The next user can then choose a new button/box or take any previous user's button/box. After a button/box is stolen a certain number of times it become ineligible to be further selected. Once all of the buttons/boxes have been selected, the contents of the buttons/boxes are revealed. Any number of products can be won.

In another embodiment, the bidding is conducted via an aggregate demand auction, wherein an auction item is priced and posted. After a certain number of predetermined users indicate their willingness to purchase the item at that price, the auction is open and valid for that discounted price. If a certain number of additional participants join the auction, the price may drop further. The auction concludes at a predetermined time.

In still another embodiment, the bidding is conducted via a negotiated price auction, wherein the price for the item is set by the software and the user makes a counter-offer. The auction is concluded if and when a price is agreed upon.

In various embodiments, a minimum dollar value must be reached before the auction can end. In other embodiments, a countdown timer is used to indicate the auction end, but if a bidder places a bid during the pendency of the countdown timer, the countdown timer resets. In still another embodiment, the auction ends at a randomly selected time and the last bidder wins the auction. In a particular embodiment, there is a maximum number of bids that can be accepted before the auction ends.

In various embodiments, if the auction ends and the user is not the top bidder (i.e. he did not win the auction), the user has the option to purchase the product he was bidding upon, or optionally, any product offered for auction, at its listed retail price. In a particular embodiment, the bids that were used in bidding for the product and were unsuccessful may be converted to currency and be debited against the price of the retail product. For example, if each bid costs $0.10 and a user bids 10 times on a $5.00 gift card, but loses the auction, he may purchase the $5.00 gift card for $4.00 (retail value—cost of bids used in unsuccessful auction). Thus, the monetary value of the bids is maintained. In an embodiment, only bids actually purchased can be redeemed in this manner. In various embodiments, the system may be configured to not allow the user to debit bids awarded free of charge against the retail cost of a product.

In an embodiment, if the user fails to use all of his bids during a particular session, those bids will be stored in his user account until he returns to the store/website. The user may utilize those bids at a later date.

### Promotional Sweepstakes Module

In an embodiment of the invention, a promotional electronic sweepstakes is offered in conjunction with the auction. Sweepstakes server 120 includes this promotional electronic sweepstakes module that provides the sweepstakes functionality.

In various embodiments, after the user has completed the bidding process, system provides the user with one or more free sweepstakes entries that may be revealed by the user. In some embodiments, the number of sweepstakes entries provided to the user may correlate with the number of bids purchased. For example, a user may be awarded one sweepstakes entry for each bid purchased. In still other embodiments, the number of sweepstakes entries allocated to the user may be proportional to the number of purchased bids. For example, the user may be allocated one sweepstakes entry for every two bids purchases (e.g. a 1:2 ratio). It should be understood that the ratio of sweepstakes entries to bids purchased may be set at any level depending on the configuration of the system. Moreover, in some embodiments, the number of sweepstakes entries allocated may vary depending on the value of each bid purchased. That is, in instances where the value of each bid is higher than a standard value, the user may be allocated a greater number of sweepstakes tickets for each bid purchased.

In various embodiments, the sweepstakes entries may be revealed in a one-by-one fashion in conjunction with an entertaining display or may be revealed immediately and simultaneously without an entertaining display. In other embodiments, the user receives the sweepstakes entries upon purchase of the bids, but cannot reveal the sweepstakes entries until bidding has begun. In still other embodiments, the bidding and sweepstakes reveal processes occur simultaneously. In these embodiments, one sweepstakes ticket may be revealed each time a bid is placed. In yet other embodiments, the sweepstakes reveal is completely optional. The user may elect to bypass the sweepstakes altogether if desired. The software may provide an option upon logging in which forces the player to choose “auction only” or “auction and sweepstakes,” or some similar designation.

The electronic sweepstakes itself operates in the same manner as a standard, non-electronic sweepstakes. Sweepstakes server 120 creates a finite set of sweepstakes entries and a finite set of prizes. The value of all prizes is predetermined and assigned to a specific sweepstakes entry before the sweepstakes begins. No function of the software or action by the customer can change the content of any sweepstakes entry once it has been created and assigned a prize. The software program randomly selects the sweepstakes entries to be distributed each time a customer initiates a purchase or otherwise directs the server to do so. The electronic sweepstakes does not require a purchase and typically has an alternate “no purchase necessary” method of entry which has the same odds of winning as the purchase-based entries, as they are all randomly drawn from the same pool. The electronic sweepstakes is also limited in time.

In an embodiment, at the time of purchase of bids, a central computer server in communication with sweepstakes server 120 and the user's computer terminal/end user terminal 140/170 randomly selects one or more sweepstakes entries for the user from a predetermined, finite pool of entries. The sweepstakes entries are then assigned to the unique account associated with that user.

In another embodiment of the invention, rather than the sweepstakes tickets being selected by sweepstakes server 120, the customer is provided with free sweepstakes points at the time of purchase. The points can be redeemed for sweepstakes tickets during selection of the sweepstakes games or during the instant reveal process. At that point in time, the sweepstakes entries are randomly selected by sweepstakes server 120. Thus, in these embodiments, the customer may select a particular entertaining game, direct the system to proceed, and sweepstakes server 120 randomly selects one or more sweepstakes tickets.

If the user elects to reveal the sweepstakes entries, the user may have the option to immediately reveal the sweepstakes results all at once or may utilize an entertaining display to reveal the results of the sweepstakes tickets one by one. The system may be designed such that this instant reveal option may be locked by the administrator, such that the sweepstakes can only be revealed in the instant reveal fashion, without the entertaining display.

In some embodiments, the entertaining display may be designed to mimic slot machine reels, a bingo game, a keno game, a poker game, a pick 'em game, a shooting game, a blackjack game, a craps game, a roulette, game, or a similar casino-style game. The games are considered “simulated games” because the games themselves have no impact on the outcome of the sweepstakes. The games are interactive, but the interaction has no impact on whether the player wins or loses. The interaction merely directs the revealing of the predetermined sweepstakes ticket. Even games that appear to be skill-based are not. Multiple game options may be available to the user via the software. The sweepstakes entries received by the customer are already predetermined as winners or losers—the customer merely uses the game as an entertaining way to reveal that result.

In various embodiments, if money is won as a prize through the sweepstakes, the software may allow the user to purchase additional bids and continue bidding on products and, if desired, revealing additional sweepstakes entries. In some embodiments, the sweepstakes prize may be points that can be converted to additional bids and utilized with in the electronic auction. In yet other embodiments, if the user declines a product won through the bidding process, the product may be allocated to the last bidder prior to the user's winning bid.

In various embodiments, if the user wins a cash prize, the user may redeem it in a brick and mortar location through point of sale terminal 160. Alternatively, the user may be issued a prepaid credit or debit card that can be activated at the brick and mortar location or mailed to the user once the prizes have been deposited thereon. The cash prizes won in the sweepstakes may be deposited onto the prepaid credit or debit card through any means know in the art. In various other embodiments, the system may store cash prizes in the user's account until the user chooses to redeem them in cash and/or on a credit/debit card.

Similar to the electronic auction configuration, in various embodiments, the electronic sweepstakes may be stored on a local server and utilized within the walls of a brick and mortar store or on a networked server that serves a particular city, county, or state. In this scenario, sweepstakes ticket pool would be limited to the users in that brick and mortar location. Alternatively, sweepstakes server 120 could be located remotely and the ticket pool could be shared across various brick and mortar locations, states, or nationwide. Even further, sweepstakes server 120 may be a main server and available over the Internet, wherein any user that has Internet access could access the sweepstakes ticket pool. In some embodiments, the auction could be linked to other locations or across the Internet, but the sweepstakes ticket pool could be local to the brick and mortar location or vice versa.

In various embodiments, the electronic auction may run on one monitor and the sweepstakes may run simultaneously on another monitor. For example, computer 140 or end user terminals 170 may include dual monitors. Alternatively, the auction and sweepstakes may run simultaneously on the same monitor. In still other embodiments, the customer may be required to utilize all bids in the auction prior to beginning the sweepstakes reveal. In other embodiments, the customer must be actively bidding or must be the highest bidder in an auction in order to reveal a sweepstakes ticket.

In various embodiments, the user may set the system preferences for the user's account with regard to auction format, auction products, sweepstakes game skins, etc., which would be applied each time the user logs in to the system. In some embodiments, the user preferences only remain active during the current user session.

In various embodiments, the system may inquire as to whether the user would like to be notified via email or text message when items of interest (e.g., items selected by the user) will be auctioned off. Upon such election, the system will monitor the particular items and when they are put on auction, the system may send the user an email or text message to notify him that an item of interest is being put up for auction.

In various embodiments, the electronic sweepstakes and auction system can be used on a mobile phone, tablet, or other mobile device. That is, a customer can (1) purchase bids over the Internet through their mobile device, (2) bid on auction items as discussed herein, and (3) reveal the sweepstakes entries, if desired, using a mobile device. It should be understood that “mobile devices are any devices that can be easily moved from location to location (e.g., tablet computers, handheld smartphones, handheld readers, iPad®, etc.). For non-smart phones, the system may provide a function that allows customers to send text messages to purchase bids, automate bidding, and provide the customer with sweepstakes results as set forth herein. In yet other embodiments, the auction and sweepstakes modules may be downloaded to a USB drive, with the appropriate security measures in place, and can be provided to a customer for home use on computer 140.

### Exemplary Online Auction and Sweepstakes Experience

FIGS. 3 and 4 depict exemplary methods for participating in an auction and a sweepstakes on a terminal. The computer 140, end user terminal 170, auction server 130, and sweepstakes server 120 may alone, or in combination, perform the method steps described in the module of FIGS. 3 and 4. It should be understood by reference to this disclosure that these methods describe exemplary embodiments of the method steps carried out by the present system, and that other exemplary embodiments may be created by adding other steps or by removing one or more of the methods steps described in FIG. 3 or 4.

At step 302, the system receives a request to purchase a first quantity of electronic bids for use in at least one electronic auction. The system may receive the request, for example, from computer 140 and/or end user terminal 170. The system may have a single auction, multiple simultaneous auctions, auctions that occur at different times, auctions based on the outcome of previous auctions, or any various combination of auctions. In some embodiments, the request may be for any quantity of electronic bids. In other embodiments, the system may place restrictions on the quantity of bids a user may purchase. For example, the system may require a minimum quantity of electronic bids. Alternatively, the system may place an upper limit on the quantity of electronic bids a user may purchase.

At step 304, the system allocates the first quantity of electronic bids to an account associated with the first user. In various embodiments, the system may require a user to log in to their account by providing credentials (e.g., a user name or account number and password or other identifying credentials). In some embodiments, the user may be asked to create an account. In still further embodiments, the system may allow a user to proceed with a one-time account or to log in as a “guest.”

At step 306, the system allocates a first quantity of electronic sweepstakes entries to the first user account. The system may allocate a quantity of electronic sweepstakes based on the allocated quantity of electronic bids. In various embodiments, the quantity of electronic sweepstakes entries may equal the quantity of electronic bids. In other embodiments, the quantity of electronic sweepstakes allocated may be based on the number and/or total amount (e.g., in dollars or cents) of the allocated electronic bids.

At step 308, the system receives a request to place a bid on a first item available in at least one electronic auction. In various embodiments, the user may request to bid all, one, or a portion of electronic bids associated with their account. The bids may be placed manually or through an automated bidding process in which the first user indicates a maximum bid they are willing to make and the system will place a new bid each time the first user is outbid by another user. At step 310, the system enables the first user to place the bid on the first item. In various embodiments, the system may notify the user that the bid has been accepted. In various embodiments, the system may display the bids for the auction on the main display screen. In other embodiments, the system may display the bids on each user's terminal or computer.

The system may display bids on items in a variety of ways. In some embodiments, the system may display the first bid of the first user and the bids of all other users. In other embodiments, the system may display the highest bid only. In still further embodiments, the auction may be a “yankee auction” where none of the bids are displayed.

At step 312, the system receives a request from the user to reveal a result of at least one of the first quantity of electronic sweepstakes entries. The system may allow the user to reveal sweepstakes entries at any time, only after an auction is complete, after a certain quantity or dollar value of bids are used, or any other suitable time. At step 314, the system enables the first user to reveal the result of the electronic sweepstakes entry.

FIG. 4 depicts a second exemplary method for participating in an auction and a sweepstakes on an end user terminal or computer. Beginning at step 402, the system receives a request from a first user to purchase a first quantity of bids. The system may receive the request, for example, from computer 140 and/or end user terminal 170. The system may have a single auction, multiple simultaneous auctions, auctions that occur at different times, auctions based on the outcome of previous auctions, or any various combinations of auctions. In some embodiments, the request may be for any quantity of electronic bids. In other embodiments, the system may sell bids is packages, for example, one hundred bids for sixty dollars. In other embodiments, the more bids the user purchases at a single time the lower the cost per bid. At step 404, the system enables the first user to purchase the first quantity of bids. A purchase may be made by credit card, debit card, check or cash. In various embodiments, the purchase may be made by bank wire or any other suitable payment method.

At step 406, the system allocates the first quantity of purchased bids and a first quantity of electronic sweepstakes entries to an account of the first user. The system may allocate a quantity of electronic sweepstakes based on the allocated quantity of electronic bids. In various embodiments, the quantity of electronic sweepstakes entries may equal the quantity of electronic bids. In other embodiments, the quantity of electronic sweepstakes allocated may be based on the number and/or total amount (e.g., in dollars or cents) of the allocated electronic bids.

In various embodiments, the system may require a user to log in to their account by providing credentials (e.g., a user name or account number and password or other identifying credentials). In some embodiments, the user may be asked to create an account. In still further embodiments, the system may allow a user to proceed with a one-time account or to log in as a “guest.”

At step 408, the system enables the first user to use at least one of the first quantity of bids to bid on a first item available in the electronic auction. In various embodiments, the system may notify the user that the bid has been accepted. In various embodiments, the system may display the bids for the auction on a computer screen or end user terminal display.

At step 410, the system receives a request to reveal at least one of the first quantity of sweepstakes entries. The system may allow the user to reveal a sweepstakes entry at any time, only after an auction is complete, after a certain quantity or dollar value of bids are used, or any other suitable time.

At step 412, at least partially in response to receiving the request to reveal one of the first quantity of sweepstakes entries, the system enables the user to reveal the sweepstakes entry. At step 414, the system enables the display of a result selected from a group consisting of the auction of the item and the reveal of the sweepstakes entry. In various embodiments, the sweepstakes entries may be revealed in a one-by-one fashion in conjunction with an entertaining display or may be revealed immediately and simultaneously without an entertaining display.

In various embodiments, the user may receive the sweepstakes entries upon purchase of the bids, but cannot reveal the sweepstakes entries until bidding has begun. In still other embodiments, the bidding and sweepstakes reveal process occur simultaneously. In these embodiments, one sweepstakes ticket may be revealed each time a bid is placed. In yet other embodiments, the sweepstakes reveal is completely optional. The user may elect to bypass the sweepstakes altogether if desired. In still other embodiments, the user may be allocated the first quantity of sweepstakes entries, but the sweepstakes tickets are not assigned to the allocated entries until the user request that a sweepstakes entry be revealed.

In still other embodiments, the system may be configured to provide an option upon logging in that forces the player to choose “auction only” or “auction and sweepstakes,” or some similar designation.

### Conclusion

Many modifications and other embodiments of the invention will come to mind to one skilled in the art to which this invention pertains having the benefit of the teachings presented in the foregoing descriptions and the associated drawings. While examples discussed above cover the use of the invention in the context a content management service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A computer-implemented method comprising:
receiving, by at least one computer processor from a first user, a request to purchase a first quantity of electronic bids for use in at least one electronic auction;
allocating, by the at least one computer processor, the first quantity of electronic bids to an account associated with the first user;
allocating, by the at least one processor, a first quantity of electronic sweepstakes entries to the first user account;
receiving, by the at least one computer processor, a request, from the first user, to place a bid on a first item available in the at least one electronic auction;
enabling, by the at least one computer processor, the first user to place the bid on the first item;
receiving, by the at least one computer processor, a request, from the first user, to reveal a result of at least one of the first quantity of electronic sweepstakes entries;
enabling, by at least one computer processor, the result of the at least one electronic sweepstakes entry to be revealed;
displaying, simultaneously, by the at least one computer processor, the at least one electronic auction and the result of the at least one electronic sweepstakes entry in association with an entertaining display; and
ending the at least one electronic auction after a maximum number of bids has been accepted;
wherein the first user must place at least one bid on the first item prior to each request by the first user to reveal one of said first quantity of electronic sweepstakes entries.

2. The computer-implemented method of claim 1, wherein the first quantity of electronic sweepstakes entries are based on the first quantity of purchased electronic bids.

3. The computer-implemented method of claim 1, wherein each one of the first quantity of electronic bids is equal to a predetermined amount of money.

4. The computer-implemented method of claim 1, further comprising displaying the result of the at least one sweepstakes entry.

5. The computer-implemented method of claim 4, wherein displaying the result further comprises displaying the result in a form that resembles the reels of a slot machine.

6. The computer-implemented method of claim 1, wherein allocating the first quantity of electronic bids further comprises:
receiving payment from the first user for the first quantity of electronic bids; and
transferring the first quantity of electronic bids to the first user account.

7. The computer-implemented method of claim 1, further comprising:
receiving, from a second user, a request to purchase a second quantity of electronic bids for use in at least one electronic auction;
allocating the second quantity of electronic bids to an account associated with the second user; and
allocating a second quantity of electronic sweepstakes entries to the account associated with the second user, wherein the second quantity of sweepstakes entries is based on the second quantity of purchased electronic bids.

8. The computer-implemented method of claim 7, further comprising:
receiving a request, from the second user, to place a bid on a second item available in the at least one electronic auction; and
enabling the second user to place the bid on the second item.

9. The computer-implemented method of claim 8, wherein the first item and the second item are the same.

10. The computer-implemented method of claim 8, further comprising:
receiving a request, from the second user, to reveal a result of at least one of the second quantity of electronic sweepstakes entries; and
enabling the second user to reveal the result of the at least one of the second quantity of electronic sweepstakes entries.

11. The computer-implemented method of claim 10, further comprising displaying, to the second user, the result of the at least one sweepstakes entry.

12. The computer-implemented method of claim 8, wherein the first user and the second user access the electronic auctions and electronic sweepstakes through a plurality of networked terminals

13. The computer-implemented method of claim 12, wherein the terminals are sweepstakes terminals that are operatively coupled to at least one central server.

14. The computer-implemented method of claim 3, further comprising, if the first user does not win the at least one auction:
receiving a request, from the first user, to purchase the first item;
enabling the first user to purchase the first item; and
allocating the bids placed by the first user toward the purchase price of the first item.

15. A system, comprising:
at least one memory storing computer-executable instructions; and
at least one processor, wherein the at least one processor is configured to access the at least one memory and to execute the computer-executable instructions to:
receive a request from a first user to purchase a first quantity of bids for use in at least one electronic auction;
enable the first user to purchase the first quantity of bids;
allocate the first quantity of purchased bids and a first quantity of electronic sweepstakes entries to an account of the first user;
enable the first user to use of at least one of the first quantity of bids to bid on a first item available in the electronic auction, wherein at least one of the first quantity of bids is automatically placed on behalf of the first user when the first user is not the high bidder on the first item;
receive, from the first user, a request to reveal a result of at least one of the first quantity of sweepstakes entries;
the result of the at least one of the first quantity of sweepstakes entries to be revealed during bidding of the at least one electronic auction;
enable the display of the result in association with an entertaining display, wherein the result is selected from a group consisting of:
on the same display as the auction of the item;
the auction of the item;
the reveal of the at least one sweepstakes entry; and
end the at least one electronic auction after a predetermined number of bids has been received;
wherein the first user may request reveal of one of the first quantity of sweepstakes entries after each one bid used.

16. The system of claim 15, wherein the quantity of electronic sweepstakes entries is dependent on the first quantity of purchased bids.

17. The system of claim 15, wherein allocating the first quantity of sweepstakes entries to the first user cannot occur prior to the first user using at least one of the first quantity of bids in the electronic auction.

18. The system of claim 15, further comprising a plurality of terminals operatively coupled to the at least one processor over a network, wherein one of the plurality of terminals is configured to receive the request to purchase the first quantity of bids from the first user and transmit the request to the at least one processor.

19. The system of claim 18, wherein the network is selected from one or more of the Internet, a wide area network and a local area network.

20. The system of claim 15, wherein display of the result of the reveal of the at least one sweepstakes entry further comprises display of the result using a simulated game selected from a group consisting of: slots, poker, bingo, craps and keno.

21. The system of claim 15, wherein the at least one processor is further configured to reveal a result for one of the first quantity of sweepstakes entries for each respective bid submitted by the first user until the first quantity of sweepstakes entries is depleted.

22. A system, comprising:
a means of allowing a first user to purchase a first quantity of bids;
a means of allocating the first quantity of bids and a first quantity of sweepstakes entries to an account of the first user, wherein the first quantity of sweepstakes entries is proportional to the first quantity of purchases bids;
a means for enabling the first user to place automatic placement of a bid on a first item up for auction at an electronic auction when the first user is not the high bidder on the first item;
a means for enabling a result of at least one of the first quantity of sweepstakes entries to be revealed;
a means for displaying, simultaneously, the at least one electronic auction and the result of the at least one electronic sweepstakes entry in association with an entertaining display; and
a means for ending the at least one electronic auction after a maximum number of bids has been accepted, wherein the maximum number is hidden from the first user.

23. The system of claim 22, wherein the means for allocating further comprises:
a means for crediting the purchased first quantity of bids to the first user account; and
a means for crediting the first quantity of sweepstakes entries to the first user account.

24. The system of claim 23, further comprising a means for linking the first user with the first user account.

25. The system of claim 22, further comprising a means for displaying a result chosen from a group consisting of:
the auction of the first item; and
the reveal of the at least one sweepstakes entries.
